(19) United States
(12) Patent Application Publication
(10) Pub. No.: US 2001/0034567 A1
(43) Pub. Date: Oct. 25, 2001

(54) Remote management of retail petroleum equipment

(76) Inventors: Marc L. Allen, Chesapeake, VA (US); Daniel S. Smith, Fort Wayne, IN (US)

Correspondence Address: RANDALL J. KNUTH P.C., 3510-A STELLHORN ROAD, FORT WAYNE, IN, 46815-4631, US

(21) Appl. No.: 09/761,271

(22) Filed: Jan. 16, 2001

Related U.S. Application Data
(60) Provisional application No. 60/177,171, filed on Jan. 20, 2000.

(51) Int. Cl. G05D 7/00; G05D 11/00; G06F 17/00

(52) U.S. Cl. 700/283; 700/241; 700/244

(57) ABSTRACT

A network management system remotely manages a fuel dispensing network comprising a plurality of refueling stations each including several fuel dispensing assemblies. The network management functions include reconfiguring the fuel dispensing equipment, downloading software updates, monitoring the status and performance of the fuel dispensing equipment, performing diagnostic and troubleshooting procedures, and scheduling maintenance calls and other servicing activity in response to the diagnostic evaluations. The management application performs its various network management functions in conjunction with a plurality of dedicated software agents each resident at a respective refueling station.

### BACKGROUND OF THE INVENTION

1. Field of the invention.

The present invention relates to fuel dispensing facilities and, more particularly, to a method and system for managing the operations of remote fuel dispensing stations utilizing a network management facility.

2. Description of the related art.

Conventional fuel dispensing stations are typically configured with refueling equipment connected to an operator terminal over a dedicated line that carries customer transaction information and control commands. The operator terminal serves simply to assist in processing the customer refueling request such as by performing an authorization check, compiling a receipt of the completed transaction, and communicating with the customer regarding various matters such as augmenting the refueling transaction with the purchase of convenient store merchandise.

These conventional refueling stations are noticeably lacking in any management functionality that enables a management application to perform various administrative tasks essential to maintaining the integrity and proper operating standards for the refueling activity. For example, it is necessary to monitor the operating status and performance of the refueling equipment to ensure that it is operating properly. This monitoring data needs to be made available to a suitable diagnostic facility in order to identify device malfunctions and perform other troubleshooting functions. Currently, however, such diagnostic procedures require a service person to physically enter the fuel dispenser cabinet area to gain direct access to the components or to make an interface connection using some form of probe or scan tool that is tethered to the equipment. In either case, the service person must conduct the monitoring activity on-site at the equipment location. Additionally, current monitoring equipment typically exists in a stand-alone configuration and therefore the monitoring data is incapable of being automatically uploaded to a service center for analysis. Service personnel currently must take the information retrieved from the refueling devices to a processing facility where a more thorough data analysis can be conducted. What is therefore needed is an improved diagnostics functionality that permits the execution of diagnostic procedures at locations remote from the dispenser equipment and which allows the monitoring data to be automatically collected and uploaded for purposes of evaluation.

Another useful function generally found in managed networks involves the capacity to reconfigure the operating parameters and software processes that run on the managed devices or machines. In a refueling station, such a feature would allow a programmer or other service personnel to selectively modify the working properties of the refueling equipment, e.g., changing the respective flow rates of the fuel pump/valve assembly and vapor recovery apparatus. However, the devices employed in conventional dispenser arrangements typically utilize control routines that are embedded within EPROMs, essentially making it impracticable to fix any programming bugs or provide software updates since this would require replacing the existing EPROM with a new EPROM having the desired software module. As a result, designers typically view the on-site refueling equipment as a static configuration incapable of handling updates or accommodating periodic reconfiguration operations. What is therefore needed is a management facility that enables software changes to be made without requiring the physical intervention found in conventional arrangements, thereby enhancing and expanding the software functionality. Additionally, there is needed a management application integrated with the refueling station that facilitates and otherwise supports device profile reconfigurations, dynamic updating of the control processes and program instruction sets, and automatic software downloads.

The globalization of commerce has meant that individual business units such as refueling stations are no longer limited in their reach to a single domestic market but are increasingly being deployed internationally. For this purpose, it is necessary to develop an administrative capability that enables a central authority to concurrently handle the various management tasks associated with each refueling station. What is therefore needed is a network manager capable of remotely managing the operations of multiple refueling sites.

### SUMMARY OF THE INVENTION

According to the present invention there is provided a method and system for enabling remote management of multiple refueling stations. A network management system provided in the form of a management application performs various administrative services in connection with remotely managing a fuel dispensing network comprising a plurality of discrete refueling stations each including several fuel dispensing assemblies. The network management functions include tasks such as configuring the fuel dispensing equipment, downloading software updates to the control devices and processor components at the refueling station, monitoring the status and performance of the fuel dispensing equipment in relation to refueling operations, diagnosing and troubleshooting malfunctions and other problems, and scheduling maintenance calls and other servicing activity in response to the diagnostic evaluations.

The management application performs its various network management functions in conjunction with a plurality of dedicated software agents each resident at a respective refueling station. In network management terms, the fuel dispensing equipment located at the individual refueling stations is viewed by the management application as managed network objects or devices. In a preferred form, the network management system encompasses a software application residing on a computer or other such machine that manages the network devices (i.e., fuel dispensing equipment) with assistance from the collection of software agents. In another preferred form, the software agent is provided in the form of software or firmware that implements SNMP (Simple Network Management Protocol) in order to provide data to the management application.

In a preferred implementation, the fuel dispensing system at each refueling station includes a plurality of operator terminals, a plurality of individual fuel dispenser assemblies, and a site management module provided in the form of a microprocessor for managing the operations of the dispenser assemblies and also for enabling communications between the operator terminals and dispenser assemblies. A network configuration is established at each refueling station in which any one of the operator terminals may communicate with any one of the fuel dispenser assemblies via the site management module. The site management module is preferably connected to the arrangement of dispenser assemblies over a high-speed, high-bandwidth communications medium (e.g., Ethernet link) utilizing the standard Transmission Control Protocol/Internet Protocol (TCP/IP).

Each fuel dispenser assembly preferably employs a Universal Serial Bus (USB) communications architecture in which a dedicated dispenser controller is connected to an associated plurality of peripheral devices using a dedicated USB bus topology. The arrangement of peripheral devices includes fuel dispensing components and user interface devices such as payment terminals and digital video displays.

In a preferred form, the on-site, dedicated software agent is resident on the computer that implements the site management module.

One advantage of the present invention is that the management application is capable of remotely performing a variety of management functions with respect to multiple refueling stations, such as monitoring the operating performance and current status of the refueling equipment, downloading software updates and reconfiguration routines, conducting troubleshooting and diagnostic operations on equipment data uploaded from the refueling station, scheduling service maintenance jobs in response to the diagnostics evaluation, and coordinating the management tasks in a manner sufficient to enable concurrent handling of the management demands of various refueling stations.

Another advantage of the present invention is that standard network management tools may be used since the refueling stations are arranged in a network configuration in which the individual fuel dispensing components (e.g., programmable valve assembly and fuel pump) are recognized as network devices capable of remote management.

A further advantage of the invention is that implementation of the network management capability at the refueling station simply requires the installation of a software agent in the site management module, for example.

A further advantage of the invention is that the management application may be integrated with a variety of Internet-enabled machines and other communication devices that facilitate making the operations of the management application available to a virtually unlimited audience such as a servicing department.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic block diagram illustration of a fuel dispenser system which employs a network management system to provide a variety of network management functions to plural fuel dispensing stations, according to one embodiment of the present invention;

FIG. 2 is a more detailed block diagram illustration of the system architecture shown in FIG. 1, according to another embodiment of the present invention;

FIG. 3 is a yet more detailed block diagram illustration of the system architecture shown in FIG. 2, according to yet another embodiment of the present invention;

FIG. 4 is a block diagram illustration of the fuel dispensing station shown in FIG. 3 that is managed by the illustrated management application according to the present invention;

FIG. 5 is a further detailed block diagram illustration of the fuel dispensing assembly shown in FIG. 4 configured in accordance with one implementation thereof;

FIG. 6 is a schematic block diagram illustration of one type of equipment configuration for the fuel dispenser assembly shown in FIG. 5;

FIG. 7 is a schematic block diagram illustration of another type of equipment configuration for the fuel dispenser assembly shown in FIG. 5;

FIG. 8 is a schematic block diagram illustration of yet another type of equipment configuration for the fuel dispenser assembly shown in FIG. 5; and

FIG. 9 shows in block diagram format one illustrative configuration for the network management system shown in FIG. 1, according to a preferred embodiment of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

By-way of overview, the present invention relates to a system that utilizes a management application or process resident within a remote network management system to perform a variety of network management functions in connection with a plurality of refueling stations. The refueling station is configured in such a manner that the array of fuel dispensing equipment is recognized and otherwise viewed by the management application as a configuration of managed network devices. In this manner, the management application need not be customized, tailored, or specially adapted for use in managing the fuel dispensing equipment. Accordingly, the present invention permits the use of standard network management tools, modules, and packages. The present invention also includes a dedicated software agent resident at the refueling station that is capable of establishing relevant communications with the individual fuel dispensing components and any other refueling station subsystems. In conventional fashion, the software agent provides cooperation and assistance to the management application that is aimed at supporting and otherwise facilitating the execution and performance of the management functions.

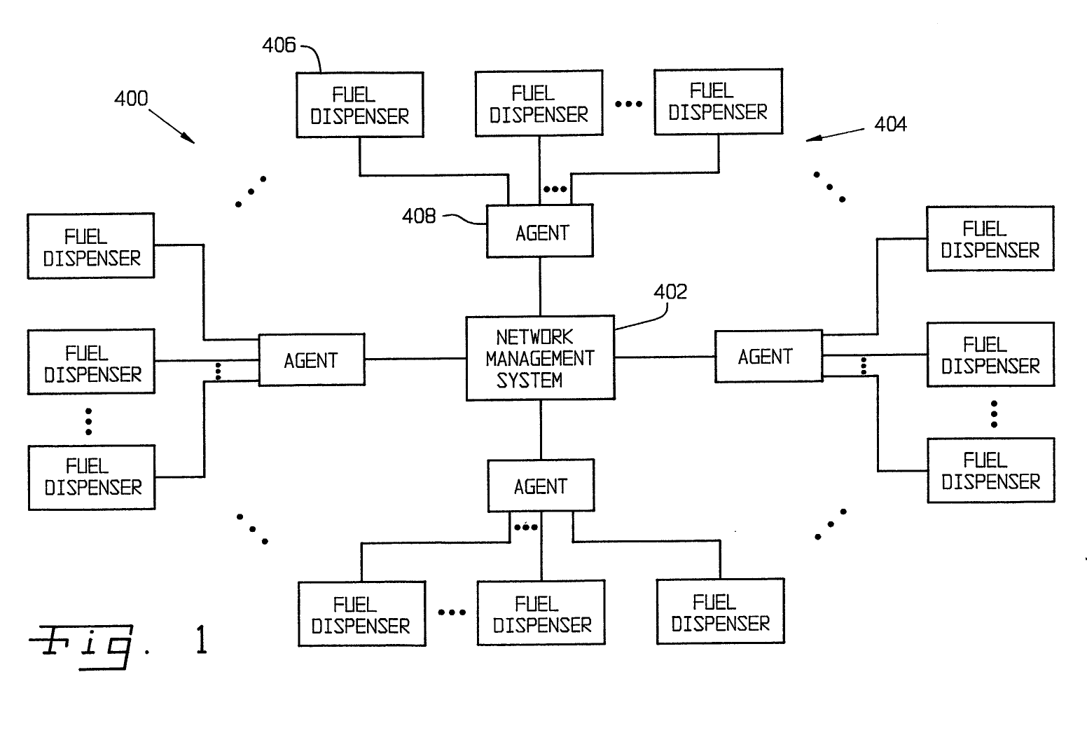

The discussion of the present invention will be organized in the following manner shown in the drawing figures. FIG. 1 shows a block diagram illustration of a fuel dispenser system 400 employing a network management system 402 that provides a variety of network management functions in relation to a plurality of individual refueling stations 404 distributed throughout a service region.

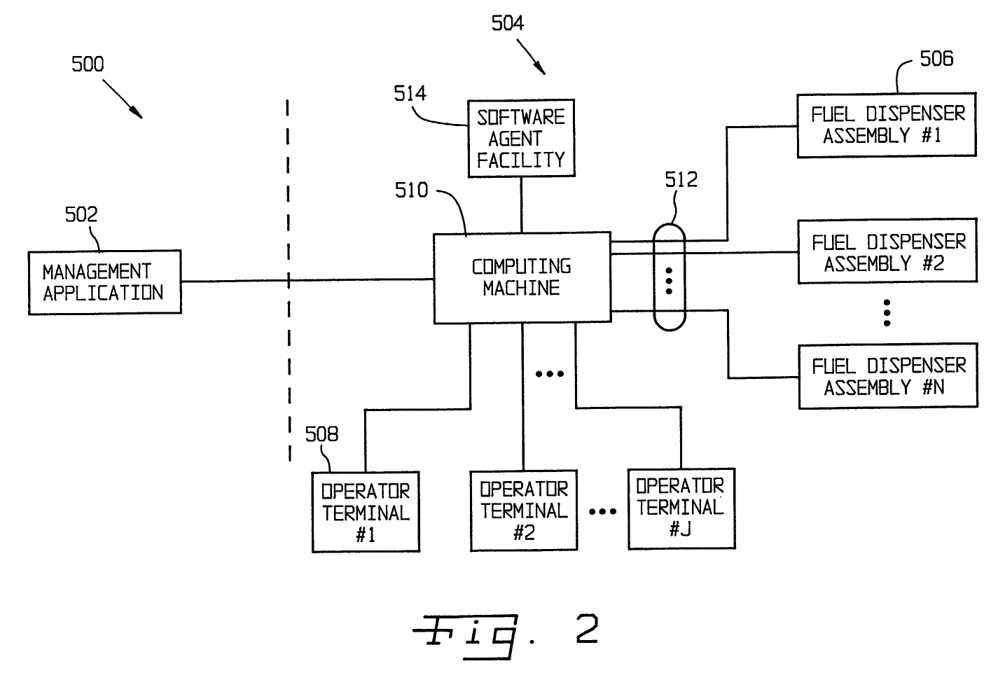

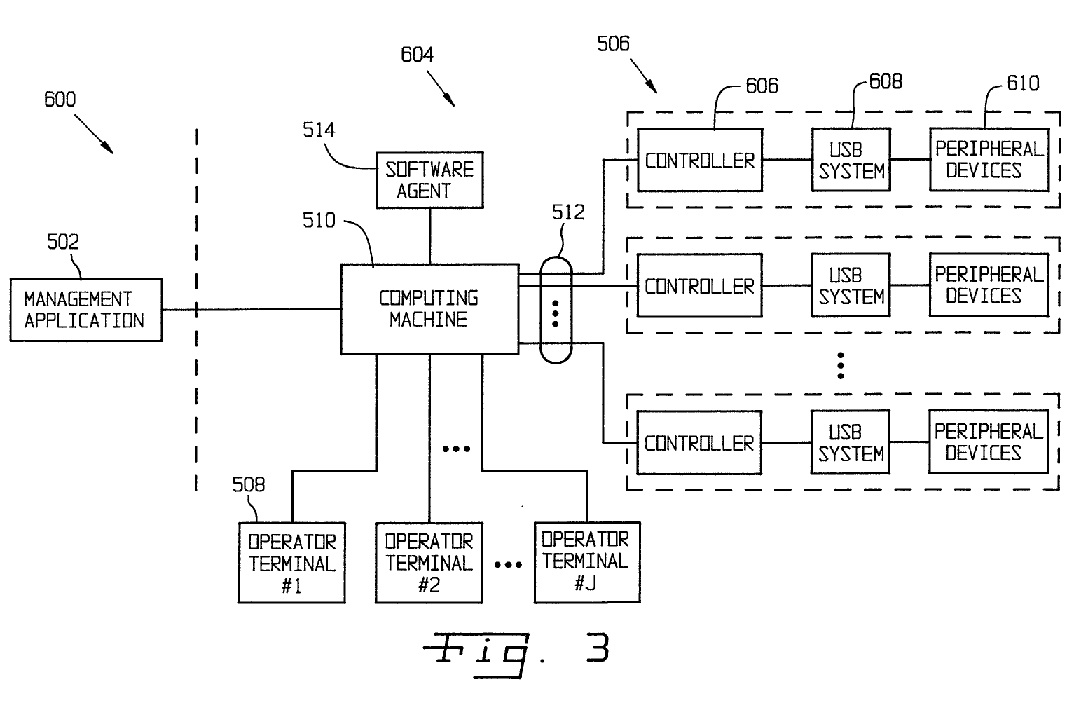

FIG. 2 provides a more detailed block diagram illustration of a fuel dispenser system 500 which employs a management application 502 that provides network management functions with respect to refueling station 504, according to one embodiment of the present invention. The arrangement depicted in FIG. 2 represents one possible implementation for the integration and configuration of network management system 402 and refueling station 404 of FIG. 1.

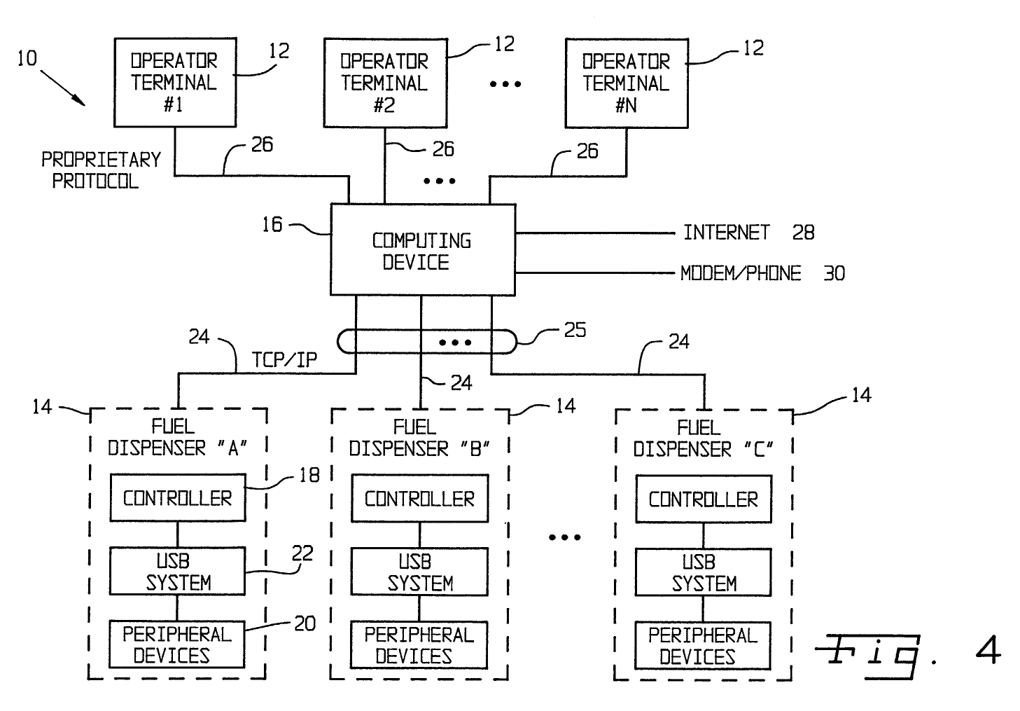

FIG. 3 provides a yet more detailed block diagram illustration of a fuel dispenser system 600 which employs management application 502 to provide network management functions with respect to refueling station 604, according to another embodiment of the present invention. The arrangement depicted in FIG. 3 (i.e., the illustrated configuration for refueling station 604) represents a preferred implementation of refueling station 504 of FIG. 2.

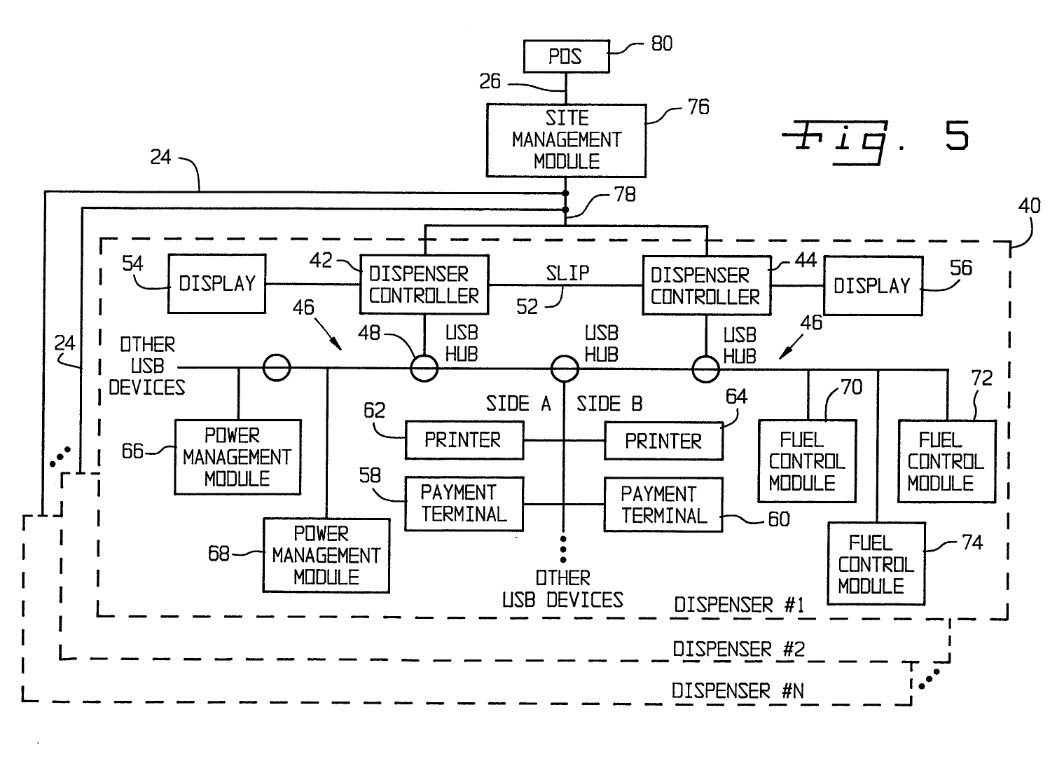

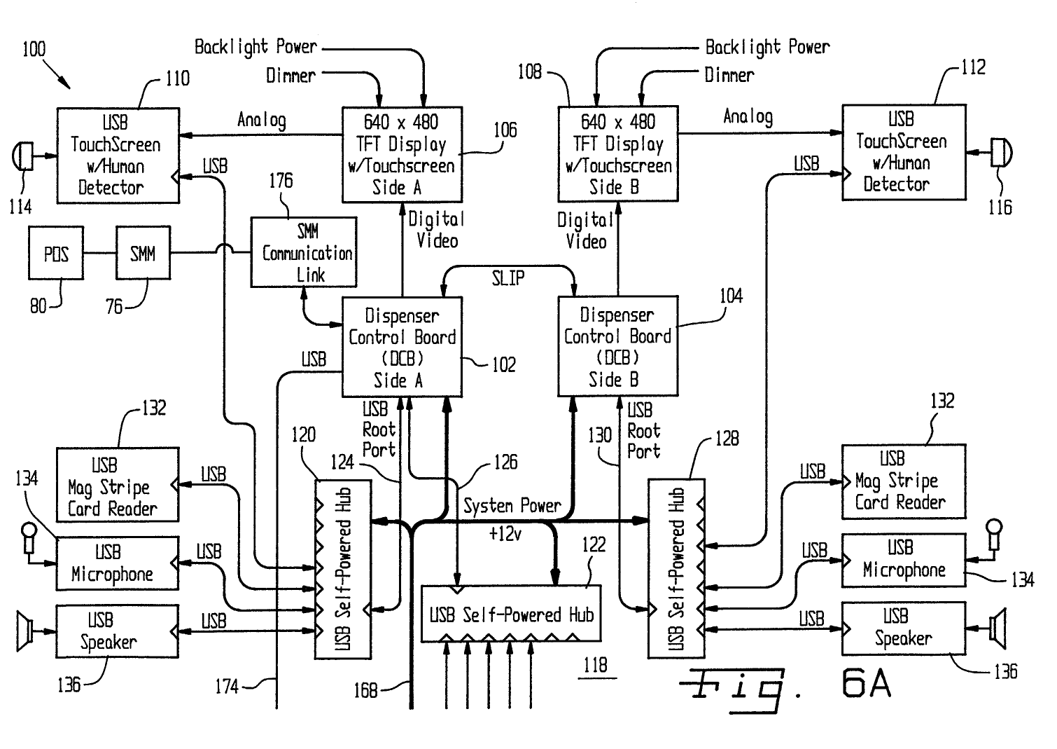

FIGS. 4-8 illustrate in block diagram format various implementations of the refueling station that may be managed by the network management system of the present invention.

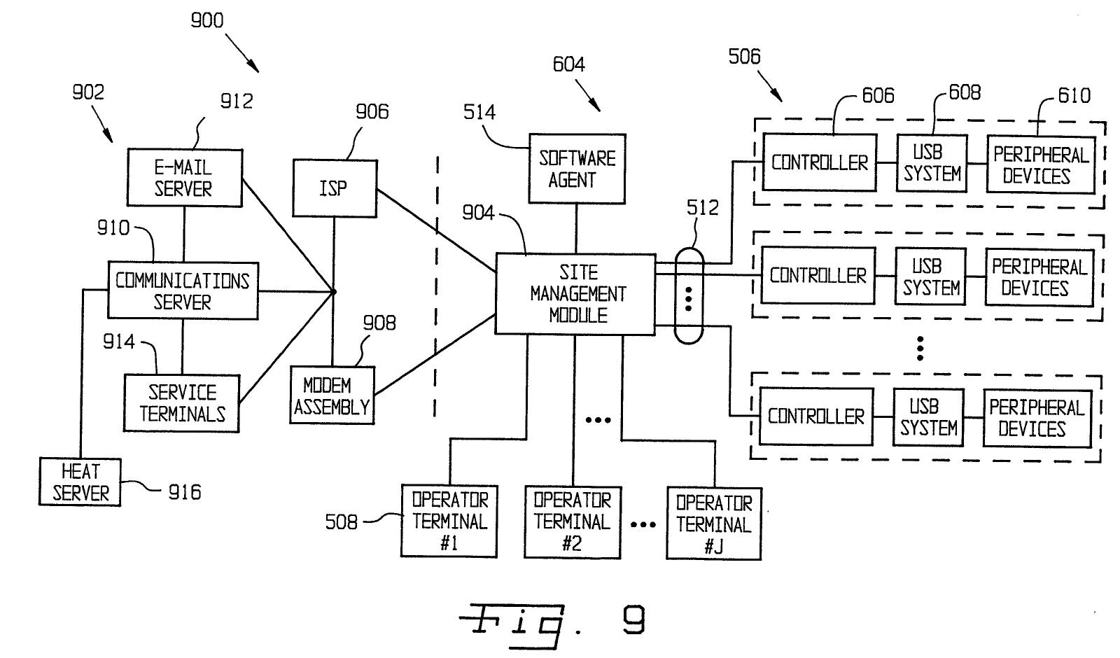

FIG. 9 shows in block diagram format one illustrative configuration of network management system 402 shown in FIG. 1, according to a preferred embodiment of the present invention.

Referring now to the drawings and particularly to FIG. 1, the illustrated network-managed fuel dispenser system 400 includes network management system 402 arranged for communication with a plurality of individual refueling stations 404 each providing fuel dispensing services to customer vehicles.

As known to those skilled in the art, refueling station 404 typically comprises an arrangement of dedicated fuel dispensers 406 each capable of servicing an associated vehicle with multiple brands of gasoline, for example. The particular configuration of fuel dispensers 406 installed at refueling station 404 should not be considered in limitation of the present invention, as it should be apparent to those skilled in the art that network management system 402 can perform its various management functions with respect to any suitably configured arrangement of fuel dispensing equipment. However, one preferred implementation encompasses the use of network management system 402 in combination with refueling stations that have fuel dispenser assemblies configured in the manner disclosed by FIGS. 3-8 herein.

For purposes of facilitating the operation of network management system 402, each refueling station 404 is equipped with an agent facility 408 that supports and otherwise enables the administrative actions, services, and other management functions performed by network management system 402. The illustrated agent 408, for example, may assist network management system 402 by performing the following functions: (i) collecting status and operational performance data associated with the individual devices and components of fuel dispenser 406, (ii) uploading such information to network management system 402, (iii) receiving and acting upon commands and other requests originating from network management system 402, and (iv) receiving and processing information from network management system 402 (e.g., software downloads and device reconfiguration instructions).

Agent 408 conventionally represents an abstraction of resources and therefore may be implemented in a variety of conventional ways. For example, agent 408 may be implemented in the form of a routine, algorithm, or process (i.e., software application) or as embedded code (i.e., firmware) resident in a computing machine, storage facility (e.g., programmable ROM), or other suitable means. It is sufficient that the chosen means for implementing agent 408 be capable of simply acting as a type of information broker, intermediary, or suitable interface between the network management tool (i.e., network management system 402) and the managed devices (i.e., the equipment represented by fuel dispenser 406).

In a preferred form, agent 408 is enabled and otherwise configured to support SNMP, i.e., the simple network management protocol that defines the manner in which SNMP management applications (which form part of network management system 402) communicate with SNMP agents to facilitate the transfer and exchange of data, commands, requests, instructions, responses, queries, and other such information in furtherance of carrying out the management functions. A useful reference in regard to further understanding these network features may be obtained from “Newton's Telecom Dictionary” by Harry Newton, published by Miller Freeman, Inc., New York, N.Y. (February 1999), incorporated herein by reference thereto.

The illustrated network management system 402 should be understood as encompassing (without any limitation thereof) a comprehensive system of procedures, processes, software, equipment, and operations designed to maintain the operating performance and efficiency of fuel dispensers 406. In one form, network management system 402 may be understood as including a software application residing on a computer that manages the network devices (i.e., the hardware/software equipment represented by fuel dispenser 406) with the assistance of agent 408.

Network management system 402 remotely performs a variety of management functions with respect to multiple refueling stations. These functions include, but are not limited to, (i) monitoring the operating performance and current status of the refueling equipment, (ii) downloading software updates, (iii) reconfiguring the fuel equipment modules, (iv) conducting troubleshooting and diagnostic operations based upon equipment data uploaded from the refueling station, (v) scheduling service maintenance jobs in response to the diagnostics evaluation, (vi) maintaining and otherwise controlling any suitable aspects of the refueling station operations, and (vii) coordinating the management tasks in a manner sufficient to enable concurrent handling of the management demands of various refueling stations (discussed hereinafter in more detail).

Referring now to FIG. 2, there is shown a network-managed fuel dispensing system 500 including a management application 502 for use in managing the operations of refueling station 504. By way of comparison between FIGS. 1 and 2, the illustrated management application 502 represents an implementation of network management system 402 (FIG. 1), while the illustrated refueling station 504 represents an implementation of refueling station 404 (FIG. 1), according to one embodiment of the present invention.

The illustrated refueling station 504 includes a plurality of fuel dispenser assemblies 506 each operative to deliver fuel to an associated customer vehicle. A plurality of operator terminals 508 are arranged for communication with the plurality of fuel dispenser assemblies 506 via computing machine 510. Computing machine 510 includes a configuration of hardware, software, firmware, or any combination thereof that enables any one of operator terminals 508 to communicate with any one of fuel dispenser assemblies 506. Computing machine 510 is also equipped with suitable means to process instructions supplied by operator terminals 508 for carrying out various operations relating to the fuel dispensing activities of fuel dispenser assemblies 506. These instructions, for example, may involve control commands directed to a fuel control module, requests for device status information in support of a monitoring operation, and the transmission of voice/video/data information for delivery to a customer-interfaced payment terminal.

The illustrated refueling station 504 also includes a communications link 512 that connects computing machine 510 to the plurality of fuel dispenser assemblies 506. The communications link 512 is preferably provided in the form of a high-speed broadband medium such as an Ethernet link that enables communications between computing machine 510 and fuel dispenser assemblies 506 to take place over a single line, with each fuel dispenser assembly being configured for connection to communications link 512. This type of broadband access finds favor over conventional schemes in which each fuel dispenser assembly is connected to a host machine over a separate dedicated physical line.

The illustrated management application 502 performs a variety of network management functions with respect to fuel dispenser assemblies 506. For this purpose, refueling station 504 is equipped with a software agent facility 514 that is preferably integrated with computing machine 510 in the form of reprogrammable software or embedded code. One example of a management application 502 capable of being utilized by the present invention is the Unicenter TNG product commercially available from Computer Associates, Inc. Information concerning this product may be obtained by reference to the Internet web site http://www.cheyenne.com. Additionally, the disclosure of another illustrative network management application for use by the present invention may be found in U.S. Pat. No. 5,958,012 issued Sep. 28, 1999 and indicating the assignee as Computer Associates International, Inc., Islandia, N.Y., incorporated herein by reference thereto.

Referring now to FIG. 3, there is shown a network-managed fuel dispensing system 600 including a management application 502 for use in managing the operations of refueling station 604. By way of comparison, fuel dispensing system 600 represents the same configuration as fuel dispensing system 500 of FIG. 2, except that refueling station 604 has been configured in the manner described below in which each fuel dispenser assembly 506 has the illustrated implementation including a controller 606, a Universal Serial Bus (USB) system 608, and an arrangement of peripheral devices 610, in accordance with another embodiment of the present invention.

In brief, the illustrated fuel dispenser assembly 506 of FIG. 3 includes controller 606 arranged for communication with computing machine 510 over communications link 512 and arranged further for communication with peripheral devices 610 over USB system 608. Controller 606 provides a control function enabling selective control of each of the components in peripheral devices 610 in response to operating commands issued by operator terminals 508 and forwarded via computing machine 510.

Peripheral devices 610 include various fuel dispensing components such as fuel control modules that regulate a programmable valve assembly, for example. However, it should be apparent that peripheral devices 610 may include (without limitation) any component or device arrangement directly involved in the delivery of fuel or otherwise related to the fuel dispensing activity, e.g., user interface equipment designed to facilitate the customer refueling transaction (i.e., payment terminals, microphone/speaker apparatus, printers, graphic user interface, for example).

Various implementations for refueling station 604, and in particular the configuration for fuel dispenser assembly 506 based on the illustrated arrangement of controller 606, USB system 608, and peripheral devices 610, are presented hereinbelow in connection with FIGS. 4-8.

Referring now to FIG. 4, there is shown in block diagram format a system 10 for use in dispensing fuel to a customer vehicle located at a refueling station site. The illustrated system 10 includes a plurality of operator terminals 12 each serving as a point-of-sale (POS) from which a service station operator may supervise, direct and otherwise participate in the refueling transaction. Operator terminals 12 are typically configured within a convenience store or other comparable building facility located on-site with the fuel dispensing equipment. As described further, system 10 provides a remote-access communications facility which enables operator terminal 12 to be alternately configured at a remote location, while continuing to maintain the same level of functionality with respect to the customer refueling process.

The illustrated system 10 further includes a plurality of dispenser assemblies 14 each arranged to control the delivery of fuel under the direction and management of a computing device 16 and to provide an interface means by which a customer can perform transaction-related operations. Computing device 16 is preferably constructed to allow multi-tasking management of the operations of dispenser assembly 14. The operational tasks undertaken by computing device 16 are conducted (at least in part) in response to customer information provided via peripheral devices 20 (discussed infra) and service operator information provided by operator terminals 12. Computing device 16 is also configured to enable communications between the plurality of operator terminals 12 and the plurality of dispenser assemblies 14 and between each one of the dispenser assemblies 14 in a peer-to-peer relationship.

The illustrated dispenser assembly 14 includes a controller 18 connected to an arrangement of peripheral devices 20 over a Universal Serial Bus (USB) bus system 22. In this configuration, controller 18 serves as the root node or hub, i.e., host machine. Peripheral devices 20 include fuel dispensing components such as the fuel pump and valve assembly and further include customer interfacing devices such as a graphical user interface (GUI) display, a payment mechanism (e.g., credit card reader), and any other components that facilitate interaction with the customer relative to requesting and otherwise performing transaction operations. Controller 18 performs the control functions needed to activate, regulate, and otherwise control the operation of peripheral devices 20.

One advantage of implementing the local communications function with a dedicated USB bus system 22 is that additional peripheral devices may be configurable within dispenser assembly 14 in accordance with the “plug-and-play” feature supported by USB bus architectures. A general description of USB bus architectures may be found in “Technical Papers: Universal Serial Bus Support For Windows CE” by Jason Black and Sridhar Mandyam, incorporated herein by reference and available at the http://www.microsoft.com Internet site.

By way of overview, USB is a high-speed communications bus used for connecting peripherals to the main processing host. USB operates at two speeds, 12 MBPS and 1.5 MBPS, and supports peripherals running at both speeds on the same bus topology. USB supports isochronous as well as asynchronous data transfers. The physical interface is via a 4-wire cable which supplies power as well as data communications. USB also supports a plug-and-play architecture wherein each peripheral is identified as it is powered up or plugged into the bus. Each peripheral is individually addressable, wherein the address and other device-specific configuration parameters are configured by the host when the peripheral is recognized. USB uses a tiered/star bus topology in which each peripheral plugs into a hub and that hub in turn may be plugged into another hub or directly into the host. The peripherals are not directly connected to one another as in a conventional bus topology, but are physically separated by use of the hubs. In general terms, although the peripherals are not directly connected to the same physical bus, it functionally appears as if all peripherals are directly connected to one another via a logical bus connection since the hubs are transparent to the application software.

In sum, the main features of a USB bus include multiple data rates over a single communications bus; 4-wire connector including power, ground and two signal lines; auto sensing/auto configuration (vis-à-vis recognizing the peripherals); tiered/star bus topology; and host-based communications protocol.

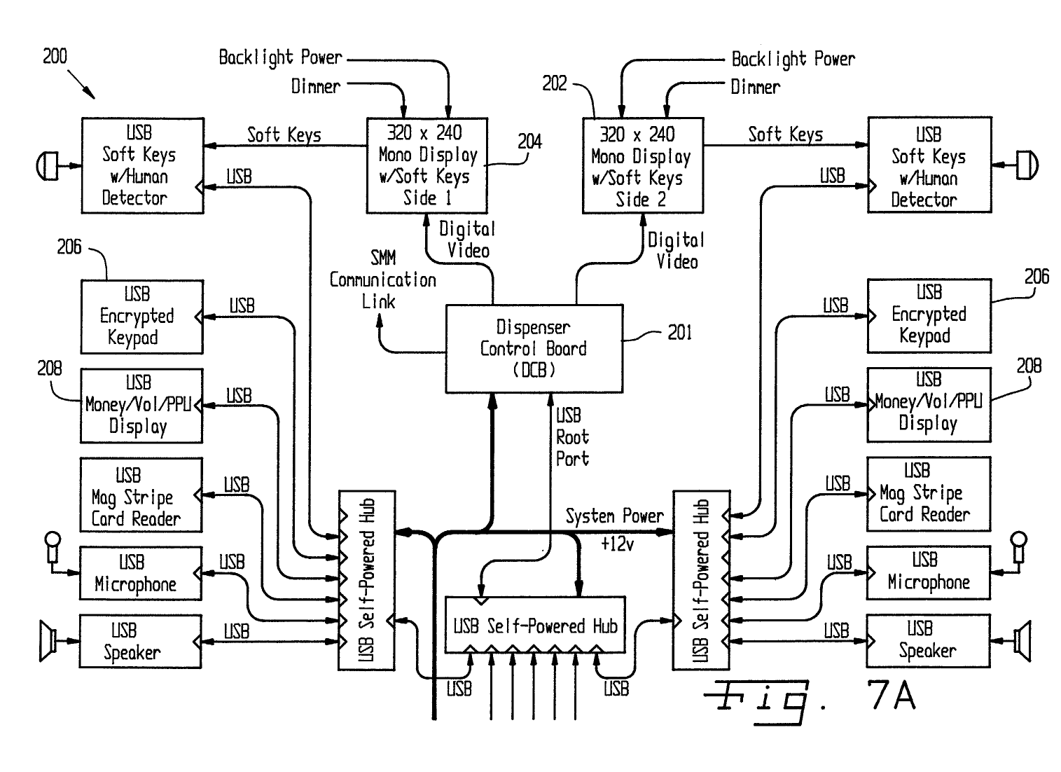

Returning to FIG. 4, the illustrated computing device 16 performs various communications, operational management, and processing tasks depending upon the level of functionality desired by operator terminal 12. In one implementation described further in connection with FIGS. 6-8, computing device 16 is configured as a site management module based upon a conventional Microsoft Windows CE-based platform running on any microprocessor arrangement well-known to those skilled in the art.

According to one feature of the present invention, the communications link 24 which is provided to facilitate communications between computing device 16 and each dispenser assembly 14 utilizes the conventional Transmission Control Protocol/Internet Protocol (TCP/IP). By contrast, the communications link 26 between operator terminal 12 and computing device 16 may utilize a proprietary communications scheme typically known as a “legacy” protocol. It is a common industry practice to use such a proprietary protocol scheme for communications directly to a POS. For this purpose, computing device 16 includes a functionality to perform a seamless protocol conversion between the proprietary protocol scheme associated with communications link 26 and the TCP/IP protocol utilized on communications link 24. Alternately, communications link 26 may support any other suitable protocol scheme such as TCP/IP.

This protocol conversion feature greatly facilitates internet communications with dispenser assembly 14 due to the near-universal use of TCP/IP as the de facto standard for internet communications. The use of TCP/IP as the basis for communications with all of the dispenser assemblies 14 enables a virtually unlimited number of access points to be provided for system 10 when computing device 16 is configured for internet access (e.g., via internet connection 28, discussed infra).

The use of both the standardized USB bus topology 22 within each dispenser assembly 14 and the TCP/IP protocol over communications link 24 allows system 10 to be characterized as an open architecture readily adapted for expansion and internet access. This distinguishes over conventional arrangements that typically have closed architectures since a proprietary protocol is used over every communications link. In such a closed arrangement, any attempt to implement a different protocol scheme would require changing the communications package resident on each of the devices or machines (e.g., removing and installing another EPROM). However, in FIG. 4, a change-over to another proprietary protocol would require only that a suitable software program module be downloaded to computing device 16.

The illustrated communications link 24 of FIG. 4 may include an Ethernet link, a wireless link, and/or a fiber optic link, although such arrangements should not be considered in limitation of the present invention as it should be apparent that any other suitable communications medium may be used.

It is a preferred feature of the present invention that communications link 24 be part of a single communications medium 25 such as a high-speed, high-band-width cable. In this manner, computing device 16 need only be equipped with a single communications interface for purposes of communicating with the plurality of fuel dispenser assemblies 14. This feature greatly facilitates connectivity between operator terminals 12 and fuel dispenser assemblies 14 since such access need only be established through a single channel, namely computing device 16 and communications medium 25. In one alternative configuration, it is possible to include more than one computing device 16, although still connected in common to a single communications medium 25. Appropriate cabling and routing methods known to those skilled in the art would be used to provide a suitable cable feed into each fuel dispenser assembly 14 for connection to the respective controller 18.

According to another aspect of the present invention, the plurality of operator terminals 12 are networked to the plurality of dispenser assemblies 14 via computing device 16 in a manner which establishes a peer-to-peer relationship that enables communications between any one of the operator terminals 12 and any one of the dispenser assemblies 14. This networked connectivity provides advantages in the event an operator terminal 12 currently handling a transaction becomes unavailable for any reason (e.g., technical problems) or otherwise goes off-line. Under these circumstances, another operator terminal 12 may go on-line (if otherwise inactive or idle) or enter a multi-tasking mode (if engaged with another dispenser assembly 14) and thereafter resume the transaction activity with the active dispenser assembly 14. This distinguishes from conventional arrangements in which the individual fuel dispensing apparatus is configured with a dedicated point-of-sale and dispenser host controller connected over a separate dedicated communications line; hence, a failure in either mechanism would disable the otherwise operational fuel dispensing apparatus.

As described further in connection with FIGS. 6-8, computing device 16 also performs pre-delivery diagnostics on peripheral devices 20 and issues operating instructions to controller 18 upon successful completion of the diagnostic procedure. For example, computing device 16 will generate commands to suitably operate the fuel pump motor and valve assembly based upon transaction data (e.g., fuel type and amount) provided by a customer via peripheral devices 20. Computing device 16 may also perform a data collection function in which it collects and stores information provided by peripheral devices 20 relating to the fuel dispensing operation (i.e., run-time operational data) and the condition of the fuel dispensing components (i.e., machine state data). This information may be retrieved or otherwise accessed by service personnel via the network management system disclosed herein to facilitate maintenance or other corrective action on peripheral devices 20. In the event dispenser assembly 14 is configured with additional peripheral devices, computing device 16 will be capable of downloading the appropriate software driver routines to controller 18.

Computing device 16 is further configured with an internet connection 28 and a modem/phone connection 30 to enable communications with remote networks and sites, namely the network management system of the present invention. Referring to the functions mentioned above in connection with computing device 16, the internet connection 28 facilitates the ability of a remote service center to access the maintenance data collected and stored in computing device 16. The data can eventually be uploaded to a processing facility for further analysis. In this manner, the operation and condition of dispenser assembly 14, and particularly the fuel dispensing components included within peripheral devices 20, may be remotely monitored to determine when a service representative needs to make a service call based upon the outcome of the data analysis.

Additionally, suitable software driver routines for newly added peripheral devices can be downloaded to computing device 16 over the internet connection 28, avoiding the need for computing device 16 to locally store such routines as resident software.

The internet connection 28 also supports conventional e-mail functions and other such messaging capabilities allowing Internet access vis-à-vis the operator terminals 12 and dispenser assemblies 14. It is even possible that the point-of-sale facility represented by operator terminal 12 may be a remote terminal connected to computing device 16 via internet connection 28.

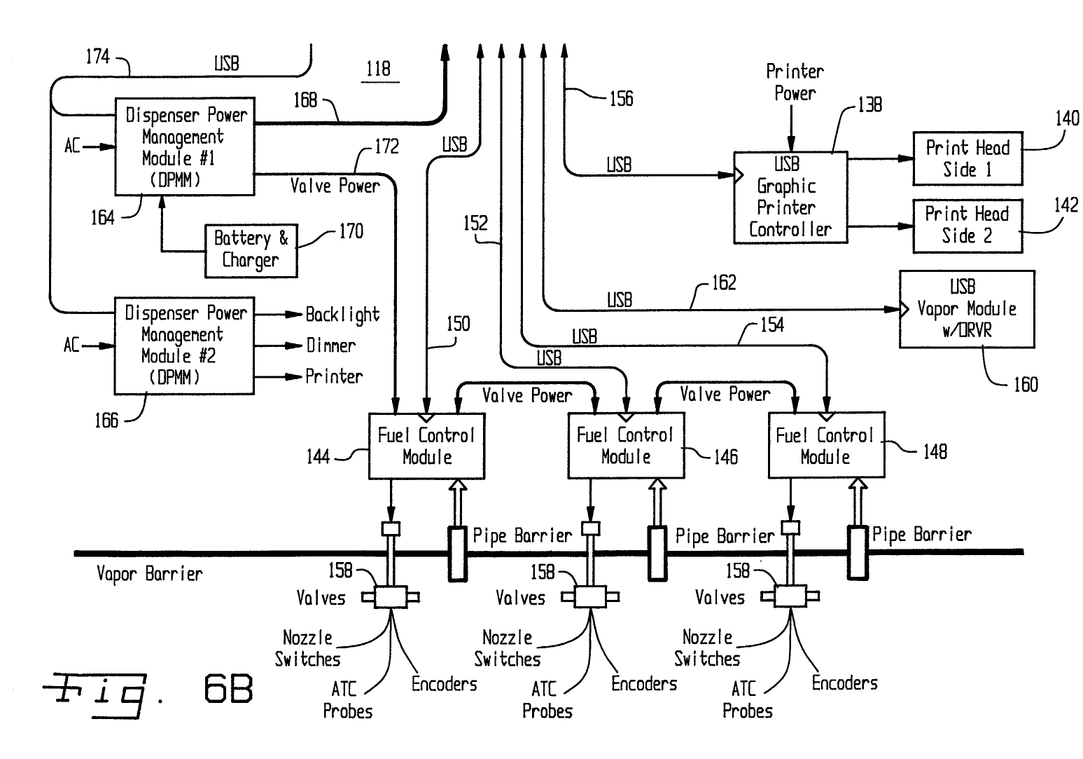

Referring now to FIG. 5, there is shown in block diagram format one illustrative implementation of system 10 of FIG. 4. More particularly, FIG. 5 shows a fuel dispenser configuration 40 representing one illustrative embodiment of dispenser assembly 14 of FIG. 4. The illustrated dispenser configuration 40 is provided with a set of dispenser controllers 42 and 44 each arranged to control the fuel dispensing components and customer interface devices associated with a respective side of a conventional two-sided dispenser structure (e.g., side A and side B). Controllers 42 and 44 are connected to the indicated peripheral device arrangement utilizing a USB bus architecture indicated generally at 46, namely via respective USB hubs 48 and 50. Controllers 42 and 44 are also directly connected to one another over a bi-directional link 52 utilizing the conventional Serial Line Interface Protocol (SLIP), for example.

A set of display terminals 54 and 56 are respectively connected to controllers 42 and 44 to serve as the interface means by which a customer can request a refueling operation, perform various other transaction-related activities, and otherwise transmit and receive information concerning the processing of the transaction. Display terminals 54 and 56 may be provided in various forms such as a graphical user interface having a touchscreen facility. For purposes of facilitating payment options, dispenser configuration 40 will include payment terminals 58 and 60 at dispenser sides A and B, respectively, which enable the customer to select and submit a form of payment (e.g., debit or credit). Printers 62 and 64 are available to print customer receipts summarizing the transaction activity. A set of power management modules 66 and 68 are provided to supply power to the electronic devices arranged within dispenser configuration 40.

The fuel delivery operation is accomplished with a set of fuel control modules 70, 72, and 74 that are connected as shown to dispenser controllers 42 and 44 over USB bus 46. Each of the fuel control modules 70, 72, and 74 operates to control a dedicated fuel dispensing valve assembly (not shown) that supplies a separate grade of fuel, for example.

The network topology illustrated by USE bus 46 should not be considered in limitation of the present invention as it should be apparent that any other such USE configuration with different hub arrangements may be possible within the scope of the present invention. It is further apparent that dispenser configuration 40 may include other arrangements of peripheral devices different from that shown in FIG. 5.

Employing USB bus 46 as the networking architecture enables additional devices to be added into dispenser configuration 40 in accordance with the plug-and-play capability offered by USB bus topologies. Integrating devices into USB bus 46 may be accomplished in a manner known to those skilled in the art and typically requires providing the proper USB-ready device interface and loading the proper device driver software into the host machine (i.e., dispenser controllers 42 and 44).

Operational control of dispenser configuration 40 is provided by a site management module 76 provided in the form of a computing device, microprocessor, or network machine (e.g., server). Site management module 76 corresponds functionally to computing device 16 in FIG. 4 and is linked to dispenser controllers 42 and 44 over a communications link 78 (which corresponds to link 24 in FIG. 4), preferably employing the TCP/IP communications protocol. The site management module 76 is interfaced to an operator associated with a point-of-sale (POS) location 80.

The specific operation of site management module 76 in conjunction with dispenser configuration 40 and POS 80 will be described in detail in connection with FIGS. 6-8. In brief, however, site management module (SMM) 76 provides operating commands to fuel control modules 70, 72, and 74 to regulate control of the fuel pump motors. SMM 76 also supplies the command information needed to manage and otherwise direct the operations of the various other peripheral devices of dispenser configuration 40. This command information is generated (at least in part) in response to instructions provided by POS 80 in the form of an application-level command set, for example.

Additionally, SMM 76 performs the necessary conversions between any proprietary communication protocols used over the POS-to-SMM link 26 and the TCP/IP protocol used over communications link 78 connecting SMM 76 to dispenser configuration 40. Information concerning the operational performance of the peripheral devices and their specific machine condition is supplied to SMM 76 via dispenser controllers 42 and 44 for subsequent analysis in order to identify substandard operations, verify proper operating ranges, and conduct maintenance evaluations. Diagnostic programs are also executed by SMM 76 as a preliminary check on the equipment prior to fuel delivery.

Referring now to FIGS. 6-8, there is shown in block diagram format various implementations of dispenser configuration 40 of FIG. 5.

Referring first to FIG. 6, there is shown a dispenser assembly 100 representative of one illustrative implementation of dispenser configuration 40 of FIG. 5. The illustrated dispenser assembly 100 would preferably be housed within the non-hazardous electronics enclosure area defined by one of the compartment spaces of a conventional fuel dispenser cabinet structure.

The illustrated dispenser assembly 100 includes a controller arrangement provided in the form of a first dispenser control board (DCB) 102 and a second dispenser control board (DCB) 104 each responsible for controlling the respective peripheral device arrangements allocated to sides A and B, respectively, of the dispenser service station terminal. First DCB 102 and second DCB 104 are each connected to respective display terminals 106 and 108 preferably provided in the form of a 640×480 TFT display with touchscreen interactivity. Each of the dispenser sides A and B is further configured with a respective USB-compatible detection apparatus 110 and 112 capable of detecting the presence of a customer (indicated representatively at 114 and 116, respectively).

The illustrated dispenser assembly 100 further includes a Universal Serial Bus (USB) bus arrangement indicated generally at 118 and including the designated USB lines and hubs, as identified hereinafter. In this USB configuration 118, DCB 102 and DCB 104 serve as the host machines, i.e., root node or hub. USB bus 118 is configured with a hub arrangement comprising USB self-powered hubs 120 and 122 each connected over respective USB connections 124 and 126 to the USB root port associated with DCB 102, and further comprising USB self-powered hub 128 connected over USB connection 130 to the USB root port associated with DCB 104.

Various USB-compatible peripheral devices are configured within dispenser assembly 100 and placed under the control of a respective one of first DCB 102 and second DCB 104 depending upon whether the device is arranged on dispenser side A or side B. For purposes of clarity, identical components provided on both dispenser side A and side B are designated with the same reference numerals.

In order to facilitate interactions with the customer, dispenser assembly 100 is provided with display terminals 106 and 108. By interacting with a touchscreen functionality well known to those skilled in the art, the customer may select the desired refueling transaction parameters from among various options presented by display terminals 106 and 108, e.g., through a series of selectable menus or graphic icons. Credit or debit payments may be made using a USB-compatible magnetic stripe card reader 132 connected to USB hub 120. Voice communications between the customer and an operator located at POS 80 are available using USB-compatible microphone assembly 134 and USB-compatible speaker assembly 136 both connected to USB hub 120 (on side A).

Dispenser assembly 100 provides a printing functionality in order to furnish the customer with a summary report of the transaction (e.g., credit card receipt). More particularly, a printing assembly is provided comprising a USB-compatible graphic printer controller 138 arranged to control a first print head 140 (dispenser side A) and a second print head 142 (dispenser side B). Printer controller 138 is connected to USB hub 122 over USB connection 156.

The illustrated dispenser assembly 100 also provides a fuel dispensing control arrangement for use in controllably dispensing fuel, which comprises a first fuel control module (FCM) 144, a second FCM 146, and a third FCM 148 connected to USB hub 122 over respective USB connections 150, 152, and 154. This arrangement of fuel control modules 144, 146, and 148 controllably regulates the fuel dispensed by respective valve assemblies 158. These fuel control modules also receive information supplied by various devices contained within the hazardous area of the fuel dispenser cabinet structure, such as temperature data from a conventional automatic temperature compensation (ATC) probe, data from encoders, and sensor data from the nozzle assembly switches indicative of nozzle activation. Dispenser assembly 100 is also configured with a USB-compatible vapor module 160 connected to hub 122 over USB connection 162. Vapor module 160 has a conventional onboard refueling vapor recovery (ORVR) functionality which provides a vacuum-assist capability enabling the collection and disposal of vapors discharged during refueling.

The illustrated dispenser assembly 100 is further configured with a power supply arrangement including a first USB-compatible dispenser power management module (DPPM) 164 and a second USB-compatible DPPM 166 having respective AC input lines. First DPPM 164 supplies operating power over power bus 168 to first DCB 102, second DCB 104, and USB hubs 120, 122, and 128. First DPPM 164 is configured with a battery and charger assembly 170 which serves as a back-up power source in the event the main AC input power supply lines are disabled or experience a low output condition. Fuel control modules 144, 146, and 148 distribute input power received from first DPPM 164 over supply line 172 in a daisy-chain arrangement. DPPM 166 provides power to printer controller 138 and to any dimmer/backlighting mechanisms configured within dispenser assembly 100 (i.e., associated with displays 106 and 108). First DPPM 164 and second DPPM 166 are both connected to at least one of the first DCB 102 and second DCB 104 over USB connection 174, which enables control and power monitoring information to be exchanged between the dispenser controllers and power modules.

The illustrated dispenser assembly 100 is configured for connection to site management module (SMM) 76 via SMM communications link 176 connected to at least one of the first DCB 102 and second DCB 104. Link 176 is preferably provided in the form of a high-speed communications medium such as an Ethernet link. Communications over link 176 preferably take place utilizing the TCP/IP protocol, as discussed previously.

POS 80 and SMM 76 are preferably located within the facility occupied by the service station operator, namely the convenience store location or any other operator site. Dispenser assembly 100 is preferably housed within the conventional electronics enclosure area typically provided within the conventional fuel dispenser cabinet structure located on-site at the fuel delivery location. It is therefore necessary to route the high-speed cable connection (i.e., SMM communications link 176) from SMM 76 into the non-hazardous area of the dispenser cabinet where the electronic components reside. Accordingly, it is preferable to use a cable-routing method that maintains the integrity of the high-speed cable (i.e., no break points) and does not require passage of the cable through the vapor barrier separating the hazardous area from the non-hazardous area.

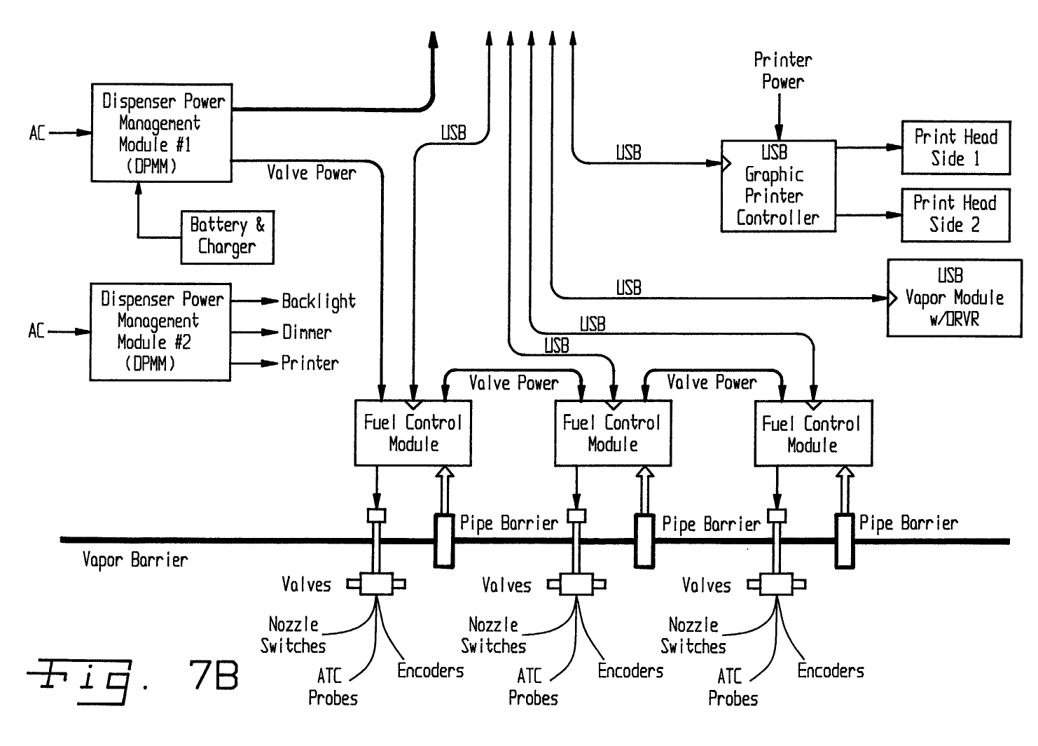

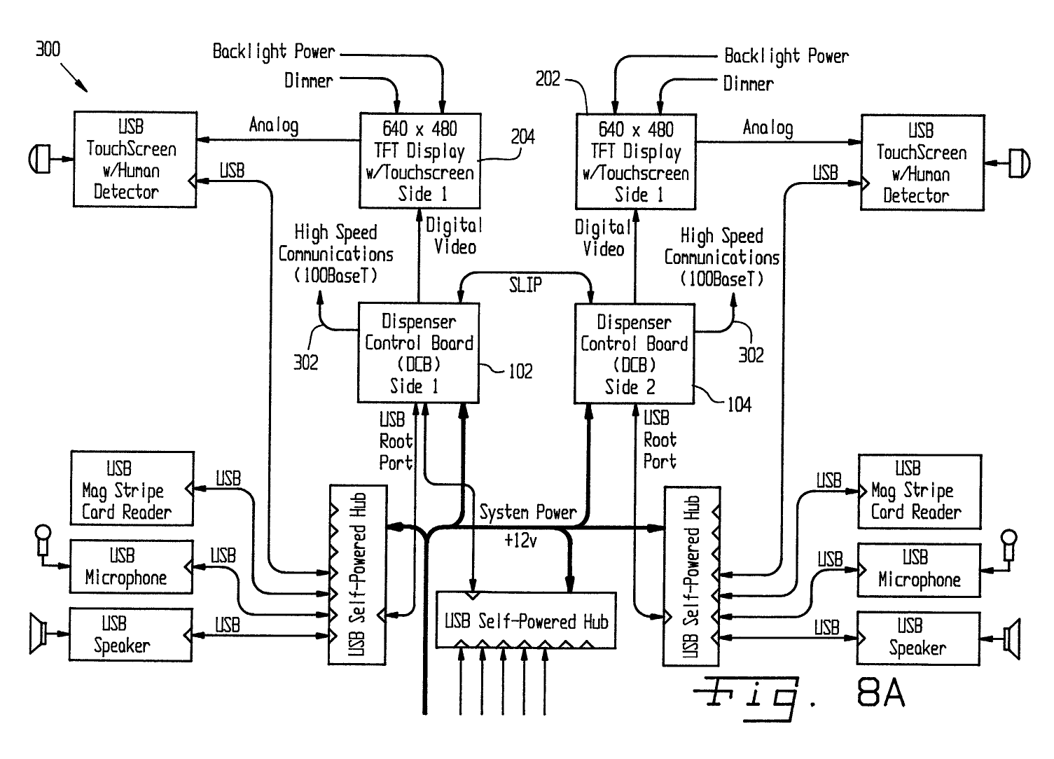

Referring now to FIG. 7, there is shown a dispenser assembly 200 representative of another illustrative implementation of dispenser configuration 40 of FIG. 5. Dispenser assembly 200 includes various modifications but otherwise is substantially identical in function and configuration to dispenser assembly 100 of FIG. 6.

The illustrated dispenser assembly 200 includes a single dispenser control board (DCB) 201 connected to a set of 320×240 monochrome displays 202 and 204 having a soft key interactive functionality. There is also provided a USB-compatible encrypted keypad apparatus 206 enabling a customer to enter transaction data and have it encrypted to protect against unauthorized use and interception. A USB-compatible sale display terminal 208 generates visual information indicative of the current transaction cost, volume of fuel dispensed, and price per unit (PPU) (e.g., price per gallon).

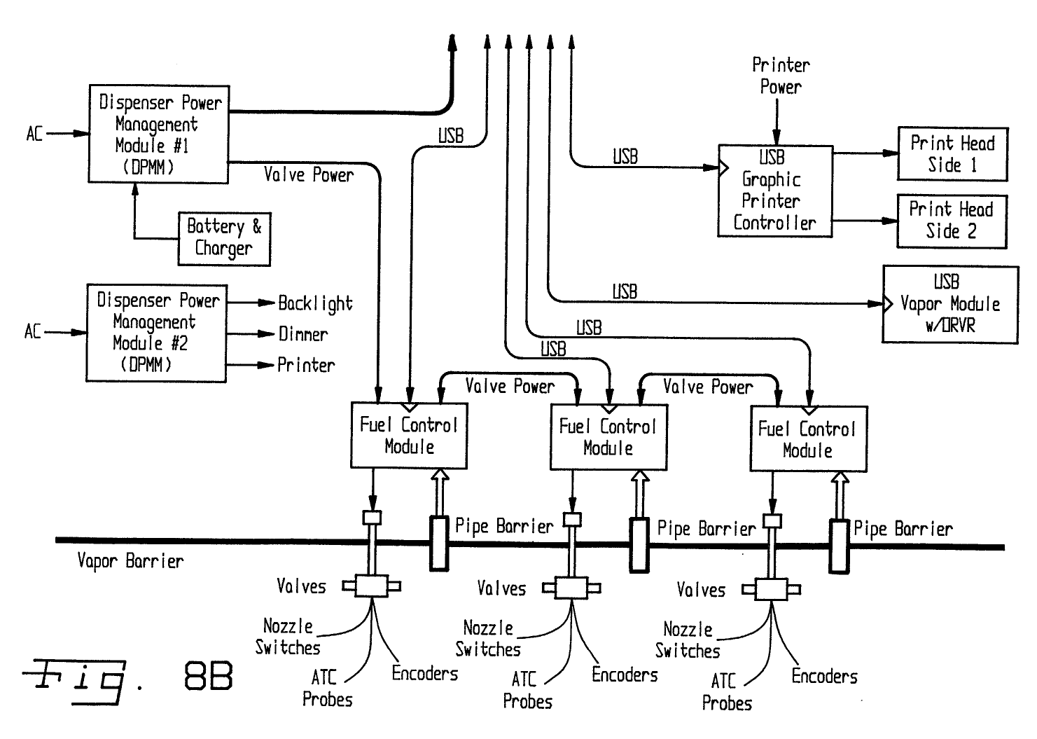

Referring now to FIG. 8, there is shown a dispenser assembly 300 representative of yet another illustrative implementation of dispenser configuration 40 of FIG. 5. Dispenser assembly 300 includes various modifications but otherwise is substantially identical in function and configuration to dispenser assembly 100 of FIG. 6.

The illustrated dispenser assembly 300 includes a high-speed, high-band-width communications link 302 (e.g., 100 BaseT) that connects first dispenser control board 102 and second dispenser control board 104 to the site management module 76 (FIG. 5). Link 302 may be provided in various forms, including Ethernet, fiber-optic, and various other such communications medium well-known to those skilled in the art.

Turning now to the operation of the fuel dispenser arrangements disclosed in FIGS. 4-8, reference is made to FIG. 6 for purposes of explanation, although it should be apparent that a similar operational description applies to the other configurations disclosed herein.

Initially, the presence of the customer would be detected by detection assembly 110 as the customer approaches the fuel dispenser terminal. A signal indicative of this detected presence is forwarded to first DCB 102, which activates the illumination capabilities of display terminal 106 via suitable control signals sent to DPPM 166 (i.e., the backlight power is brought up to full intensity). Otherwise, display terminal 106 remains in a dimmer mode pursuant to a screen saver functionality during idle periods.

The operator at POS 80 may interact with the customer over a bi-directional voice communications channel utilizing microphone 134 and speaker 136. At this point, the user is prompted (either by the operator or via instructions automatically appearing on display terminal 106) to submit payment either using card reader 132 or in accordance with any of the other payment options listed on the screen of display terminal 106. The refueling request and payment information are submitted to the operator for further processing, namely to authorize the transaction request in a conventional manner. Once sale authorization occurs, the operator reports this event to site management module 76 which issues instructions to commence fuel delivery, such as prompting the customer to operate the nozzle assembly, i.e., remove it from its receptacle, insert it into the vehicle, and engage the lever.

It is preferable to include within the transaction experience an attract-mode feature which enables dispenser assembly 100 to automatically and dynamically make a sales presentation to the customer via a series of running audio/video/data screens appearing on terminal display 106. Conventional display terminals include a preset series of generic payment options which are conveyed to the customer. However, in accordance with a preferred aspect, customer profiling data indicating the purchasing preferences of customers across various demographic groups can be represented by a series of graphic images depicting various merchandising options other than fuel which are being made available to the customer. The particular arrangement of images that are shown to the customer can be dynamically tailored to the customer preferences based upon the purchasing choices entered into display terminal 106.

For example, a series of images can depict a customer exiting the vehicle, approaching the fuel dispensing terminal, enacting a sale (e.g., via debit, credit, or cash), operating the nozzle assembly, and ordering additional merchandise while waiting for the fuel sale to be completed. If the customer becomes enticed by the illustrated non-fuel merchandising option, a simple touchscreen entry can activate an additional sequence of images that depict the various products available within the convenience store. In this manner, the customer can be effectively “taught” or induced into purchasing merchandise through these advertisement screens. Other functions are possible, for example, such as customer access to the internet when SMM 76 is configured for internet connection.

Returning to the fuel dispensing operation, once the refueling transaction has been authorized, site management module 76 conducts a series of pre-delivery operations aimed at verifying the integrity of the fuel dispensing components. More particularly, SMM 76 executes a diagnostics procedure (such as ramp failures) to determine the operational readiness of the dispenser control board 102 and fuel control modules 144, 146, and 148. The results of the various preliminary tests discussed herein are reported to SMM 76 for evaluation.

After the initial diagnostic check is completed, the start sequence is initiated, which includes activating the fuel pump motor. This motor control function can be handled either by SMM 76 or locally by a USB-compatible pump motor controller (not shown) configured within USB 118 of dispenser assembly 100. A segment check is also performed concurrently with enablement of the start condition for the pump motor.

After the segment check is complete (and subsequent to the motor pump having been activated) SMM 76 directs that a leak detection test be performed by conventional leak detection circuitry (not shown). Once all of the preliminary tests have been completed and the condition of the components has been validated by SMM 76 as operationally ready, SMM 76 formulates an operating command or other such instruction for transmission to DCB 102 to finally commence the delivery of fuel. More particularly, DCB 102 generates the appropriate control signals in response to the issued operating commands and forwards them to the proper one of the fuel control modules 144, 146, or 148, which then activates the associated valve assembly to begin the delivery of fuel.

The relevant fuel control module receives input data from a quadrature sensor/encoder that is integrally configured with the fuel pump motor to detect the pump rotational motion and transmit the detected rotational information to DCB 102 via the fuel control module. The rotational information is indicative of fuel volume and may then be used by DCB 102 to calculate the cost of the refueling sale.

The fuel control module is optionally responsible for linearizing the actual flow meter and performing the electronic calibration of this flow data as it is being generated. The fuel control module optionally receives data from the automatic temperature compensation (ATC) probes and associates the sensed temperature with the volume data being generated by the quadrature encoder. This data is collected, for example, over 10 millisecond intervals and then forwarded to DCB 102 along with any error indications identified by the fuel control module. DCB 102, in turn, calculates the temperature-adjusted volume and then uses this analysis to make any adjustments to the fuel blending process or to turn off the valves in the event of a disabling error.

When the fuel control module data indicates that the preset amount of dispensed fuel has been reached, DCB 102 sends a signal to the fuel control module to shut off the valve assembly. The valves are preferably regulated in a manner characterized first by a low-slope operation and then a total shut-off condition. In a blend application, the valves will go to a low-slope operation which is essentially a restricted flow rate. In the dual stage valve configuration, the fuel control module turns off each valve in sequence. At this time, the sale has been completed.

The first DPMM 164 plays a key role during dispenser operation to ensure that sufficient power is supplied to the system and to take appropriate action when power-related error conditions are identified. For example, when the monitored AC input power is inadequate or otherwise invalid, DPPM 164 sends an error condition to DCB 102 over USB line 174 to prevent fuel delivery or to terminate fuel dispensing if it is currently in progress. DPPM 164, for its part, will terminate the valve power otherwise provided along power supply line 172 connected to fuel control module 144. Battery and charger assembly 170 will only provide power sufficient to keep the user interface devices activated (e.g., display terminal 106). Assembly 170 is not used, however, to power the fuel dispensing components during the time the main AC power is inadequate or unavailable.

All of the information generated within dispenser assembly 100 that is present before, during, and after fuel dispensing is preferably made available not only to the particular POS 80 which is currently handling the transaction but also to every other point-of-sale location that is equipped with an operator terminal linked to SMM 76. Additionally, information from all other dispenser assemblies conducting separate refueling transactions are available to the various operator terminals due to their interconnection with SMM 76. In this manner, any operator terminal can monitor the activity of any one of the dispenser assemblies 100 throughout the entire system.

This access enjoyed by SMM 76 with respect to each of the dispenser assemblies 100 provides numerous benefits when combined with the retrieval function of SMM 76, namely the collection of information generated by each dispenser assembly 100. The information that is uploaded to SMM 76 includes, but is not limited to, the results of the diagnostic checks, any error conditions, transaction data, and signals representing the various state changes of the devices, such as valve opening, commencement of fuel flow, opening of a pilot valve, and the sensor data. Transaction data includes the fuel volume currently dispensed, price, and total cost.

This collected information finds particular use in the context of developing a maintenance program which involves monitoring the peripheral devices and the fuel dispensing components. Service personnel will be particularly interested in the data groups which reflect both the performance of the devices and their electromechanical integrity (e.g., machine state data).

To monitor and access this information, SMM 76 can be equipped with an interface mechanism enabling a service person to retrieve the data stored by SMM 76. The access point can be co-located with SMM 76, for example, as in the case of a portable scan tool/analyzer instrument, or can preferably be located at a remote operator terminal (e.g., laptop or palm device) having access to SMM 76 over an internet connection. In particular, service personnel in communication with the network management system of the present invention can receive this monitoring information. These service options are superior to those available with conventional maintenance approaches, which typically require a service person to interface directly with the individual devices by employing a probe installed in the fuel dispenser cabinet area.

This remote access to dispenser assembly 100 enables the service personnel to remotely exercise individual ones of the peripheral devices and fuel dispensing components according to an equipment diagnostics plan. The device monitoring data can be uploaded to a central processing and analysis facility (i.e., network management system of the present invention) as it is being generated or at selected intervals. The data analysis permits certain failure trends to be detected as part of a predictive maintenance program. By identifying actual problems and errors, service personnel will not be dispatched needlessly. Remote monitoring of the refueling transaction is also possible.

Referring now to FIG. 9, there is shown a fuel dispensing system 900 including refueling station 604 operatively connected to a network management system (NMS) 902 configured in accordance with a preferred embodiment of the present invention. The illustrated refueling station 604 is identical to that disclosed in FIG. 3, except that computing machine 510 (FIG. 3) has been implemented in the form of a site management module (SMM) 904 that corresponds functionally to the illustrated site management module 76 disclosed in connection with FIGS. 5-6.

By way of review, refueling station 604 includes an arrangement of fuel dispenser assemblies 506 each including a dedicated controller 606 connected to an associated arrangement of peripheral devices 610 using a Universal Serial Bus (USB) topology 608. The dispenser assemblies 506 are connected to site management module 904 that manages the operations of the dispenser assemblies 506 (namely, the peripheral devices 610) and enables communications between the operator terminals 508 and dispenser assemblies 506. A single high-speed, high-band-width communications link 512 preferably employing the TCP/IP communications protocol connects the dispenser assemblies 506 to SMM 904.

The illustrated network management system 902 includes an internet service provider (ISP) 906 that serves as a communications backbone for establishing a connection between refueling station 604 (via SMM 904) and NMS 902 that facilitates access to the Internet. For this purpose, SMM 904 will preferably be equipped with a conventional modem facility (not shown) to enable a dial-in connection to ISP 906. This modem facility may be optionally implemented with cellular modem technology that would effectively provide refueling station 604 with a permanent connection to the Internet. One example of ISP 906 would be America Online (AOL).

The use of ISP 906 should not be considered in limitation of the present invention as it should be apparent that other suitable means may be provided to connect SMM 904 to NMS 902 and to the Internet. For example, NMS 902 may optionally include a modem assembly 908 that enables a connection to be established between NMS 902 and SMM 904. The connectivity may occur over conventional POTS (plain old telephone service) facilities, but can be extended to include other communications mediums such as wireless links, fiber optics, and/or cable systems using DSL, for example.

The various management functions performed by NMS 902 with respect to refueling station 604 will now be discussed.

### Downloading Software and Configuration Updates

The illustrated NMS 902 includes a communications server 910 that incorporates a network management application such as the previously mentioned Unicenter TNG product available from Computer Associates. Communications server 910 is capable of downloading (via ISP 906 or modem assembly 908) updated versions of software applications installed on SMM 904. For this purpose, it is preferable that the applications running on SMM 904 be reprogrammable.

Additionally, fuel dispenser assemblies 506 preferably have a reconfigurable implementation such that the various operating attributes, parameters, and other such device properties may be selectively modified. In particular, the operating parameters of peripheral devices 610 and the control function implemented by controller 606 may be adjusted. For this purpose, communications server 910 is provided with a functionality capable of issuing the appropriate commands necessary to controllably reconfigure the parameters of selected devices and components at refueling station 604. This reconfiguration operation is preferably achieved in conjunction with software agent 514.

The initiation and execution of the software and configuration control preferably occurs by personnel activating this functionality on communications server 910 using a web-based access mechanism or through a separate web server. The software updates and reconfiguration profiles may be submitted by a user or optionally retrieved from a suitable storage facility. For example, the illustrated NMS 902 includes a bay of service terminals 914 representing a technician service desk where personnel may coordinate the software and configuration downloads through communications server 910.

Software updates would be needed, for example, to modify or update the operating system installed on SMM 904, enhance the functionality of SMM 904 with newly added applications programs, supply the appropriate device driver routines when new peripheral devices are attached to USB system 608, and modify (i.e., reprogram) the control function of controller 606. Additionally, there may be a need to update the functionality of certain peripheral devices such as the customer payment terminals by adding new menu screens, incorporating additional graphic icons representing an expanded list of merchandising options, and developing other such transaction-related features. In this manner, the functionality of refueling station 604, and in particular the customer transaction experience, may be dynamically modified.

In addition to reconfigurations involving the fuel dispensing equipment, changes to station-level configurations may also be undertaken.

### Monitoring the Performance and State Condition of Equipment

An integral feature of NMS 902 is its ability to collect and analyze monitoring and diagnostic information uploaded from refueling station 604 and to develop servicing tasks in accordance with the results of the data analysis. This maintenance program requires that relevant information on the performance and status of the fuel dispensing equipment be provided to NMS 902. The illustrated communications server 910 acts as the central control facility providing the basic diagnostic integration and acquisition function of NMS 902.

Software agent 514 is capable of querying any of the systems in refueling station 604 for information indicative of the device performance and status, particularly concerning the fuel dispensing components represented within peripheral devices 610. This monitoring data may be obtained and transmitted by software agent 514 to NMS 902 on a continuous basis, at selected intervals, automatically, in response to a request from communications server 910, or in any other suitable manner.

The illustrated NMS 902 preferably includes an e-mail server 912 specifically dedicated to receiving the diagnostics information provided by refueling station 604, particularly when the information has not been requested and is being uploaded on a continuous basis. The simplest method undertaken by software agent 514 in submitting the monitoring data involves packaging it in the form of an e-mail message and forwarding it to a particular diagnostics account on e-mail server 912. Each diagnostics account would correspond to an associated fuel dispenser assembly 506, for example. The e-mail server 912 is preferably equipped for web-based access to enable internet retrieval of the diagnostics information.

The diagnostics messages archived on e-mail server 912 may be retrieved in any suitable manner by communications server 910 or any other data processing facility provided at NMS 902 or at another location in communication with NMS 902. In other configurations of NMS 902, communications server 910 may optionally receive the diagnostics information directly from refueling station 604.

Personnel interfacing with service terminals 914 have the ability to retrieve uploaded diagnostics information from communications server 910 or e-mail server 912. Additionally, service terminals 914 enable remote access into any refueling station 604 to make requests of software agent 514 regarding the retrieval of any available diagnostic information.

Monitoring and diagnostics data may also be collected on a system-level basis in addition to the lower end equipment, e.g., fuel dispensing devices.

### Performing Troubleshooting and Diagnostics Procedures

One of the key management functions performed by NMS 902 involves ensuring that the fuel dispensing equipment at refueling station 604 operates at an acceptable level. Maintaining a high degree of performance integrity requires a facility capable of early detection and resolution of any malfunctions or substandard device conditions. To this end, NMS 902 is preferably equipped with a data analysis facility adapted to evaluate the monitoring information and propose any corrective action, e.g., scheduling a service call to replace a device. The data processing facility may form part of communications server 910.

One type of diagnostics evaluation involves a predictive maintenance program which conducts a trending analysis of the monitoring data to forecast the occurrence of potential problems. In this manner, the possibility of catastrophic failures is identified and avoided by taking the appropriate corrective actions. Another diagnostics method involves comparing the monitoring data against certain standard benchmarks representing performance baselines.

### Scheduling Service Calls

NMS 902 includes a functionality that initiates and otherwise schedules various courses of action based upon the results of the diagnostics evaluation described above. For example, a service call may be scheduled which involves dispatching a technician to a refueling station 604 for which an operational problem has been identified and a resolution has been developed. Additionally, regular maintenance visits may be scheduled notwithstanding the results of any diagnostics evaluation.

According to a preferred aspect of the present invention, the scheduled maintenance visits and problem resolution jobs are formulated into a service ticket by a ticket tracking system provided in the form of a HEAT server 916. The ticket tracking system generates a service ticket in response to an indication received from the diagnostic data processing facility of NMS 902 that a particular corrective action needs to be taken. The service ticket therefore includes information identifying the refueling station 604, the affected fuel dispenser assembly 506 and the particular device under review, the problem that was identified, and the proposed resolution, e.g., replacement of the device, reset its operation, or suitably modify its working parameters (i.e., a reconfiguration). The service ticket also may simply request a maintenance item.

The activity of opening new tickets on HEAT server 916 will preferably be carried out by communications server 910 since server 910 will preferably have the facility to conduct the diagnostics evaluation. Service terminals 914 are suitably interfaced with HEAT server (a type of a current conventional service desk ticket tracking system) 916 to enable technicians to receive notice of the generated service tickets and handle them in any appropriate manner.

### Generating an Audit Trail of Every Communications Session

NMS 902 preferably includes a facility associated with communication server 910 that generates a summary report of every communication that occurs between refueling station 604 and NMS 902. The report details when the communication took place, the number and type of exchanges (e.g., control commands, instruction sequence, responses, data transferred), the communicating entities (i.e., the originator and destination/recipient addresses), and any other pertinent characterizing information.

### Controlling the Fuel Dispensing Operation

NMS 902 is also equipped with suitable control routines and processes enabling it to remotely control and otherwise manage the on-site fuel dispensing operations of refueling station 604 in the event SMM 904 becomes disabled or non-functioning.

### Additional Management Functions

NMS 902 is also capable of coordinating the management tasks and functions across multiple refueling station sites and customers. Moreover, NMS 902 is a scalable configuration enabling its management operations to be expanded so that additional members (i.e., service station facilities) can participate in the network management system and be governed by the administration of the network manager.

The above management functions performed by NMS 902 may be optionally carried out and otherwise executed in a manual mode or automatically in accordance with a predetermined operational specification.

A viewing apparatus is preferably included at NMS 902 to display any aspects of the management functions, such as the diagnostics information and evaluation results.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system, comprising:
a plurality of fuel dispenser sites each having a plurality of fuel dispenser positions;
a system administrator to provide remote management of said plurality of fuel dispenser sites;
a plurality of agent facilities, each agent facility associated with a respective fuel dispenser site to operatively cooperate with said system administrator in the management of the respective fuel dispenser site; and
a connection between said system administrator and said plurality of fuel dispenser sites.

2. The system as recited in claim 1, wherein said system administrator enabling the execution of at least one management task, said at least one management task including at least one of downloading software relating to a fuel dispenser site activity, downloading software relating to a fuel dispenser position activity, downloading reconfiguration information, updating and/or modifying software resident at a fuel dispenser site, reconfiguring at least one fuel dispenser site and/or at least one fuel dispenser position, monitoring at least one of fuel dispensing operation, fuel dispenser site status and fuel dispenser position status, issuing commands to enable control of a fuel dispensing operation, evaluating diagnostic information operatively received from a fuel dispenser site, and scheduling at least one of a software download, a configuration download, and a service call in response to the diagnostic information evaluation.

3. The system as recited in claim 1, wherein said system administrator enabling the execution of a troubleshooting operation, said troubleshooting operation comprising receiving diagnostic information from at least one fuel dispenser site, evaluating the received diagnostic information, and generating a site servicing decision based upon the evaluation.

4. The system as recited in claim 3, wherein the generation of the site servicing decision comprises generating a service request when the evaluation indicates the occurrence of at least one servicing event.

5. The system as recited in claim 3, wherein the generation of the site servicing decision comprises scheduling tasks including at least one of a software upgrade, a software modification, and a fuel dispenser site component reconfiguration, wherein the scheduled tasks being performed by said system administrator.

6. The system as recited in claim 3, wherein the generation of the site servicing decision comprises generating an electronic service call ticket and forwarding the service call ticket to a service facility.

7. The system as recited in claim 3, further comprises:
a storage facility operatively associated with said system administrator, said storage facility for storing at least one of the received diagnostic information, the diagnostic evaluation results, and the generated site servicing decision.

8. The system as recited in claim 1, wherein at least one fuel dispenser position further comprises:
an interface device enabling at least one of the entry of information, the viewing of entered information, the viewing of information provided to the one fuel dispenser position, and the selection of refueling control parameters.

9. The system as recited in claim 1, wherein said system administrator enabling the execution of at least one refueling control management task, said at least one refueling control management task including at least one of receiving a refueling request, receiving a refueling control parameter selection, processing at least one of the refueling request and the refueling control parameter selection, and issuing refueling control commands in accordance with the processing operation.

10. The system as recited in claim 1, wherein said system administrator comprises a management application computer, and wherein at least one agent facility comprises a software process.

11. The system as recited in claim 1, wherein said connection comprises a network enabling communication among said plurality of fuel dispenser sites.

12. The system as recited in claim 1, wherein said connection comprises an internet, wherein at least one fuel dispenser site being enabled for internet communications.

13. The system as recited in claim 12, wherein said internet comprises the Internet enabling access to the World Wide Web.

14. A management system for use with a fuel dispenser environment, said fuel dispenser environment comprising a plurality of fuel dispenser locations each having a plurality of fuel dispenser positions, said management system comprising:
a remote management application facility, said management application facility enabling the execution of at least one management task involving at least one fuel dispenser location;
a plurality of interface means each operatively associated with a respective fuel dispenser location, each interface means operatively acting in cooperation with said management application facility to manage at least one of the fuel dispenser positions associated therewith; and
a means to connect said management application facility with at least one fuel dispenser location.

15. The management system as recited in claim 14, wherein at least one interface means further comprises a software agent.

16. The management system as recited in claim 14, wherein said management application facility comprises at least one server, and wherein at least one interface means comprises a client machine.

17. The management system as recited in claim 14, wherein at least one interface means further comprises an agent machine operatively arranged in a network configuration with the fuel dispenser positions associated therewith.

18. The management system as recited in claim 14, wherein the at least one management task executable by said management application facility including at least one of downloading software relating to a fuel dispenser location activity, downloading software relating to a fuel dispenser position activity, downloading reconfiguration information, updating and/or modifying software resident at a fuel dispenser location, reconfiguring at least one fuel dispenser location and/or at least one fuel dispenser position, monitoring at least one of fuel dispensing operation, fuel dispenser location status and fuel dispenser position status, issuing commands to enable control of a fuel dispensing operation, evaluating diagnostic information operatively received from a fuel dispenser location, and scheduling at least one of a software download, a configuration download, and a service call in response to the diagnostic information evaluation.

19. The management system as recited in claim 14, wherein said management application facility enabling the execution of at least one refueling control management task, said at least one refueling control management task including at least one of receiving a refueling request, receiving a refueling control parameter selection, processing at least one of the refueling request and the refueling control parameter selection, and issuing refueling control commands in accordance with the processing operation.

20. The management system as recited in claim 14, wherein said management application facility enabling the execution of a troubleshooting operation, said troubleshooting operation comprising receiving diagnostic information from at least one fuel dispenser location, evaluating the received diagnostic information, and generating a dispenser location servicing decision based upon the evaluation.

21. The management system as recited in claim 20, wherein the generation of the dispenser location servicing decision comprises generating a service request when the evaluation indicates the occurrence of at least one servicing event.

22. The management system as recited in claim 14, wherein said connection means includes a network.

23. A system for use with a fuel dispenser environment, said fuel dispenser environment comprising a plurality of fuel dispenser sites each having a plurality of fuel dispenser positions, said system comprising:
a remote network management facility, said network management facility being operatively arranged in a network configuration with at least one fuel dispenser site, said network management facility enabling the management of at least one fuel dispenser site;
a plurality of agent systems, each agent system associated with a respective fuel dispenser site and disposed to enable operative communication with at least one fuel dispenser position associated therewith; and
a means for enabling communication between said network management facility and at least one fuel dispenser site.

24. The system as recited in claim 23, wherein at least one agent system being operatively arranged in a network management configuration with the fuel dispenser positions associated therewith.

25. The system as recited in claim 23, wherein said network management facility enabling the execution of at least one management task, said at least one management task including at least one of downloading software relating to a fuel dispenser site activity, downloading software relating to a fuel dispenser position activity, downloading reconfiguration information, updating and/or modifying software resident at a fuel dispenser site, reconfiguring at least one fuel dispenser site and/or at least one fuel dispenser position, monitoring at least one of fuel dispensing operation, fuel dispenser site status and fuel dispenser position status, issuing commands to enable control of a fuel dispensing operation, evaluating diagnostic information operatively received from a fuel dispenser site, and scheduling at least one of a software download, a configuration download, and a service call in response to the diagnostic information evaluation.

26. The system as recited in claim 23, wherein said network management facility enabling the execution of a troubleshooting operation, said troubleshooting operation comprising receiving diagnostic information from at least one fuel dispenser site, evaluating the received diagnostic information, and generating a site servicing decision based upon the evaluation.

27. The system as recited in claim 26, wherein the generation of the site servicing decision comprises generating a service request when the evaluation indicates the occurrence of at least one servicing event.

28. The system as recited in claim 26, wherein the generation of the site servicing decision comprises scheduling tasks including at least one of a software upgrade, a software modification, and a fuel dispenser site component reconfiguration, wherein the scheduled tasks being performed by said network management facility.

29. The system as recited in claim 23, wherein said network management facility enabling the execution of at least one refueling control management task, said at least one refueling control management task including at least one of receiving a refueling request, receiving a refueling control parameter selection, processing at least one of the refueling request and the refueling control parameter selection, and issuing refueling control commands in accordance with the processing operation.

30. A method for use with a fuel dispenser environment, said fuel dispenser environment comprising a plurality of fuel dispenser sites each having a plurality of fuel dispenser positions, said method comprising the steps of:
remotely executing management operations involving at least one fuel dispenser site, said management operations comprising at least one of:
downloading software relating to a fuel dispenser site activity,
downloading software relating to a fuel dispenser position activity,
downloading reconfiguration information,
updating and/or modifying software resident at a fuel dispenser site,
reconfiguring at least one fuel dispenser site and/or at least one fuel dispenser position,
monitoring at least one of fuel dispensing operation, fuel dispenser site status, and fuel dispenser position status,
controlling a fuel dispensing operation,
evaluating diagnostic information operatively received from a fuel dispenser site, and
scheduling at least one of a software download, a configuration download, and a service call in response to the diagnostic information evaluation.

31. The method as recited in claim 30, wherein said management operations further comprise generating a site servicing decision based upon the diagnostic information evaluation.

32. The method as recited in claim 30, wherein the fuel dispensing operation control step further comprises the steps of:
receiving at least one of a refueling request and a refueling control parameter selection;
processing at least one of the refueling request and the refueling control parameter selection; and
issuing refueling control commands in accordance with the processing operation.

33. The method as recited in claim 30, wherein the step of remotely executing management operations further comprises the steps of:
providing a remote network management application facility;
providing at least one agent facility each operatively associated with a respective fuel dispenser site, each agent facility operatively acting in cooperation with said network management application facility to manage at least one of the fuel dispenser positions associated therewith; and
connecting said network management application facility with at least one fuel dispenser site.
